(19) United States
(12) Patent Application Publication
(10) Pub. No.: US 2003/0035019 A1
(43) Pub. Date: Feb. 20, 2003

(54) Wiper actuator and spittoon assembly

(75) Inventors: Steven J. Dietl, Ontario, NY (US); David Cipolla, Rochester, NY (US)

Correspondence Address: Patent Documentation Center, Xerox Corporation, Xerox Square 20th Floor, 100 Clinton Ave. S., Rochester, NY, 14644, US

(73) Assignee: Xerox Corporation

(21) Appl. No.: 09/933,388

(22) Filed: Aug. 20, 2001

(51) Int. Cl. B41J 2/165

(52) U.S. Cl. 347/33; 347/36

(57) ABSTRACT

A combination wiper actuator and spittoon assembly, which includes a service station for a printhead having a body and a spittoon assembly connected to the body. The spittoon assembly includes a spittoon having a receptacle. An elevation device is used to elevate the spittoon assembly with respect to the rest of the service station and a latch is used to maintain the spittoon assembly in an elevated position. Finally, a wiper is supported by the spittoon assembly and is used to wipe the printhead when the spittoon assembly is in an elevated position. A latch release tab is also disclosed. Also disclosed is a spring connecting the spittoon assembly to a wall of the service station.

### FIELD OF THE INVENTION

The present invention relates generally to a system for cleaning the nozzle face of a fluid ejecting printhead with a wiper blade, and more particularly to a combination wiper actuator and spittoon assembly. The system in embodiments is not limited to nozzle cleanings, but can also include other systems where a fluid ejecting device needs to be wiped. The combination of a wiper and fluid receptacle may have far-reaching uses.

### BACKGROUND OF THE INVENTION

A prior art ink jet printer of the so-called “drop-on-demand” type has at least one printhead from which droplets of ink are directed towards a recording medium. Within the printhead, the ink is contained in a plurality of channels and energy pulses cause the droplets of ink to be expelled, as required, from orifices at the ends of the channels.

In a thermal ink jet printer, the energy pulses are usually produced by resistors, each located in a respective one of the channels, which are individually addressable by current pulses to heat and momentarily vaporize ink in the channels which contact the resistors.

It has been recognized that it is beneficial to maintain the ink ejecting orifices of an ink jet printer, for example, by periodically cleaning the orifices when the printer is in use, and/or by capping the printhead when the printer is out of use or is idle for extended periods.

Inkjet printhead nozzles commonly become plugged with ink blobs or particulate, or otherwise contaminated with internal bubbles that prevent the nozzles from operating properly, resulting in lower print quality. Consequently, inkjet printers typically include a service station that provides for spitting and wiping of printheads in order to keep the printhead nozzles clean and functioning.

Wiping in conventional service stations is typically done with a single wiper that wipes the printhead in each of two directions. This is undesirable because wiping an inkjet printhead in two directions results in recontamination of a printhead during wiping, and wiping multiple printheads with a single wiper surface results in inter-printhead contamination.

Previously, wiper blades have been mounted below a surface of a movable sled and extended through a hole in the surface. Generally, it is desirable to render the wiper blades as stiff as possible, without damaging the printhead, so that the most effective wiping will be obtained.

Examples of prior art printhead wiping systems include:

U.S. Pat. No. 6,189,995 discloses a replaceable inkjet printhead service module for each separate inkjet printhead. The module comprises a head cleaner that includes a spittoon for catching ink used when servicing and calibrating the printheads, a wiper used to wipe the face of the printhead, and a cap, which is used to protect the printhead when it is not in use.

U.S. Pat. No. 6,019,466 discloses a multicolor liquid ink printer that includes a first spit station at a first short end, and a second spit station at a secured short end. The spit stations are for purging each full width array printhead between successive printing movements of the bi-directionally movable sheet driving and printing assembly from one short end to the other.

U.S. Pat. No. 6,000,780 discloses a service station for use with an inkjet printer. The service station includes a sled that is mounted to the printer's chassis. Caps and wipers can be mounted on the sled for each of the printer's movable carriage-mounted printheads. During wiping, ink can be spit from the print cartridge on to the wiper to enhance wiping.

U.S. Pat. No. 5,997,128 discloses a translational inkjet printhead servicing station including a collapsible spittoon having a mouth that collapses during a portion of the servicing routine to save space. The service station includes a printhead wiper blade having a tip that removes ink residue from the printhead.

U.S. Pat. No. 5,984,450 discloses an inkjet printer with multiple printheads in a carriage with service station functions divided between a first service station and a second service station. The first service station has a wiper dedicated to the black ink printhead that moves across a stationary nozzle array in a first wiping procedure. The first service station also provides spittoon services to all printheads.

U.S. Pat. No. 5,943,071 discloses a maintenance station of an ink jet printer including a blade cleaning station wherein a wiper blade assembly provides independent cleaning of different portions of the front nozzle face of a multi-segment ink jet printhead. Adjacent the movable wiper blade holder, in the direction away from the printing zone and at a predetermined location along the translating path of the print cartridge, is a collection surface, sometimes referred to as a spit station or spittoon. After the print cartridge has been away from the maintenance station for a specific length of time, the carriage will position the print cartridge at this collection surface.

The disclosures of all of the above patents are hereby incorporated by reference in their entirety.

### SUMMARY OF EMBODIMENTS OF THE INVENTION

Embodiments of the present invention relate to a service station for a printhead, comprising a body, a spittoon assembly connected to the body, the spittoon assembly including a spittoon having a receptacle, an elevation mechanism for elevating the spittoon assembly with respect to the rest of the service station, a wiper supported by the spittoon assembly for wiping the printhead when the spittoon assembly is in an elevated position, and a latch for maintaining the spittoon assembly in an elevated position while the wiper is in contact with the printhead. Embodiments of the present invention also disclose a spring connecting the spittoon assembly to a wall of the service station, where the spring being used to bias the spittoon assembly to an unelevated state.

### BRIEF DESCRIPTION OF THE DRAWINGS

Aspects of the present invention will become apparent from the following description and upon reference to the figures, which represent embodiments.

FIG. 1 is a schematic front elevation view of a typical cartridge having two printheads that can be used with embodiments of the invention;

FIG. 2 is a perspective view of an embodiment of a maintenance station in its rest position;

FIG. 3 is a perspective view of an embodiment of a maintenance station in its wipe position;

FIG. 4 is a left side view of an embodiment of a maintenance station in its rest position;

FIG. 5 is a left side view of an embodiment of a maintenance station in its wipe position;

FIG. 6 is a schematic view of a print cartridge with two printheads approaching a maintenance station in its rest position;

FIG. 7 is a schematic view of a print cartridge with two printheads engaging a maintenance station in its rest position;

FIG. 8 is a schematic view of a print cartridge with two printheads engaging a maintenance station in a wipe position;

FIG. 9 is a schematic view of a print cartridge with two printheads exiting a maintenance station in its wipe position;

FIG. 10 is a schematic view of a print cartridge with one printhead approaching a maintenance station in its rest position;

FIG. 11 is a schematic view of a print cartridge with one printhead engaging a maintenance station in its rest position;

FIG. 12 is a schematic view of a print cartridge with one printhead engaging a maintenance station in a wipe position;

FIG. 13 is a schematic view of a print cartridge with one printhead exiting a maintenance station in its wipe position.

### DETAILED DESCRIPTION OF EMBODIMENTS

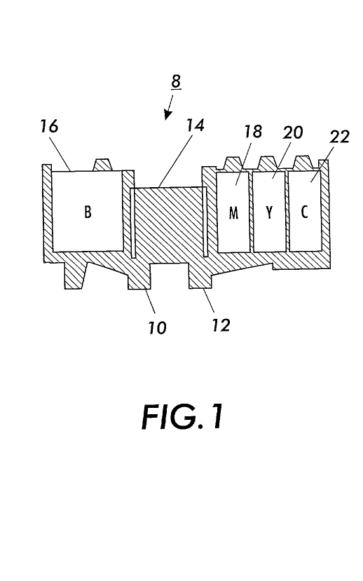

FIG. 1 illustrates an embodiment of a print cartridge 8 that can be used with embodiments of this invention. In embodiments, print cartridge 8 includes two printheads 10 and 12 that are fixed to ink supply cartridge 14. In embodiments, ink supply cartridge 14 is divided into four containers: a chamber 16 for holding a reservoir of black ink; a chamber 18 for storing magenta ink; a chamber 20 for storing yellow ink; a chamber 22 for storing cyan ink. The chamber 16 containing black ink is fluidly connected with the first printhead 10. The three chambers (18, 20, 22) containing color inks are connected to the second printhead 12. The cartridge 14 is removably mounted on a carriage (not shown), and selectively translates back and forth on a carriage guide rail or rails (not shown), so that the printheads (10, 12) and cartridge 14 move concurrently with the carriage. Printheads 10 and 12 each include a plurality of ink channels (not shown) that terminate in nozzles (not shown) in a nozzle face and carry ink from the chambers to the nozzles. It should be noted that these chambers 16, 18, 20, and 22 could contain inks of other colors and the particular colors contained in these chambers should not be considered limiting. Also, the cartridge does not have to have exactly 4 chambers. The cartridge may contain more or fewer chambers, and the exact number of chambers should not be considered limiting.

Generally, when a printer is in a printing mode, the carriage translates or reciprocates back and forth across and parallel to a printing zone. Ink droplets are selectively ejected on demand from the printhead nozzles onto a recording medium, such as paper, in the printing zone to print information thereon one swath at a time. During each pass or translation in one direction of the carriage, the recording medium is stationary, but at the end of each pass, the recording medium is advanced a distance of the height of one printed swath. At the end of a printing operation or termination of the printing mode by the printer, the carriage can be moved past one or more fixed wiper blades, so that the printhead nozzle face is wiped free of ink and debris. For a more detailed explanation of ink jet printers and printing thereby, refer to U.S. Pat. Nos. 5,432,538 and 6,130,684, the disclosures of which are totally incorporated herein by reference. These patents are only referenced to give examples of types of ink jet printers and the embodiments of the invention disclosed below are not limited to the printer embodiments disclosed therein.

Outside the printing zone, ink jet printers typically include a maintenance or service station that includes a collection container, also known as a spit station or spittoon. Generally speaking, a spittoon is a collection container having at least one receptacle for receiving fluids.

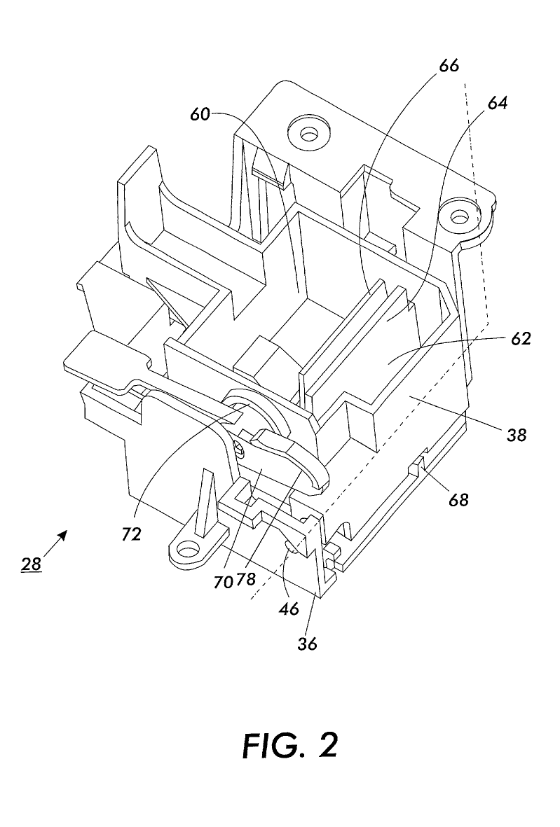

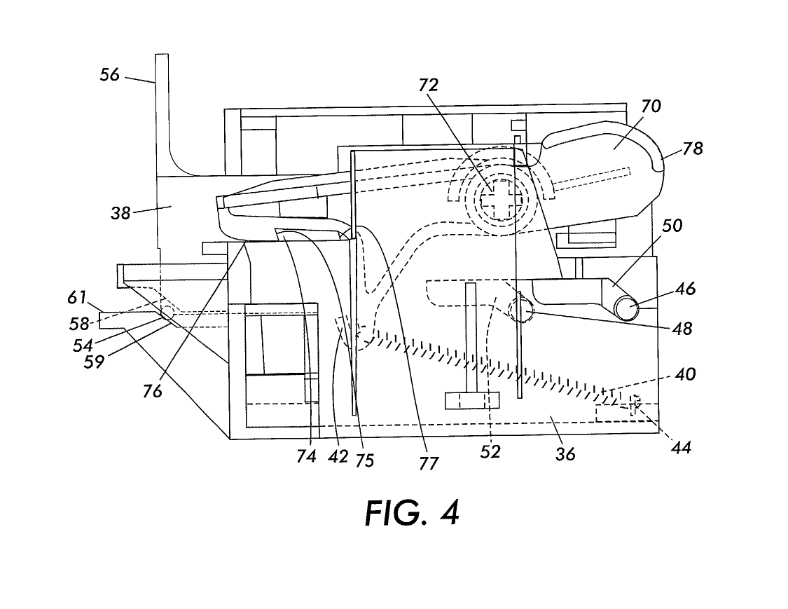

FIGS. 2 through 5 illustrate an embodiment of the service station 28 that includes a spittoon assembly 38. The spittoon may or may not be fixedly mounted. The carriage will position the print cartridge 8 at this spittoon assembly 38 after the print cartridge 8 has been away from the maintenance station for a specific length of time, even if continually printing. The carriage will do this because not all of the nozzles will have ejected enough ink droplets to prevent the ink or meniscus in the little used nozzles from drying and becoming too viscous. Accordingly, the print cartridge 8 will be moved by, for example, a carriage motor (not shown) under the control of the printer controller (not shown). Once the print cartridge confronts the spittoon assembly 38, the printer controller causes the printhead 10 or the printhead 12 to eject a number of ink droplets therein.

The spittoon may contain a pad of absorbent material (not shown). The pad of absorbent material would absorb ink and would be partially exposed to the atmosphere, so that the liquid portion of the ink absorbed therein would evaporate, thereby maintaining adequate ink storage volume for repeated subsequent cycles of priming and nozzle clearing droplet ejections. The spittoon also may contain an opening (not shown) located so that ink can drain therethrough into a pad of absorbent material located behind/below the spittoon.

The service station 28 includes a main body 36, and a spittoon and wiper blade assembly 38. The assembly 38 is connected to the body by a spring 40. One end of the spring is connected to a first hook 42 attached to the assembly 38 and the other end is attached to a second hook 44 located on the bottom front edge of the body 36. The spring 40 tends to keep the assembly 38 in its lowered or rest position.

Hook 42 is more precisely attached to lever arm 70, which is in turn attached to assembly 38. The lever arm 70 could freely rotate about an axis 72 were the spring 40 not supplying a constant torque at its point of connection, hook 42. In embodiments, the hook 42 can be attached to other parts of the assembly 38. However, the latching mechanism described in detail further on would have to be modified or replaced. For example, if the hook were attached somewhere else on the assembly, the lever arm could have a weighted end or some other feature to create torque.

In addition to the connection between the assembly 38 and the body 36 provided by spring 40, the assembly 38 is interlocked with the main body 36 in three other locations. Two of these interlocks are small cylindrical protrusions (46, 48) that extend outward from the assembly 38 and protrude through slots (50, 52) in the body 36. The third additional interlock includes a cylindrical protrusion 54 that extends from the base of backstop 56 and under overhang 58. The slots (50, 52), overhang 58, and inclined ramp 59 guide the movement of the spittoon assembly with respect to the body.

It should be noted that slots (50, 52) represent a particular embodiment. Anyone skilled in the art would know that grooves would be as, or almost as, effective as slots in guiding protrusions (46, 48).

The assembly 38 also has two spittoon receptacles (60, 62). The first spittoon receptacle 60 is used to accumulate black ink from printhead 10 and the second spittoon receptacle 62 is used to collect ink from printhead 12. A central dividing wall 64 separates these two receptacles. Wiper blade 66 extends from the top of the central divider 64. When a wipe is desired the carriage can be moved approximately 6 mm to the left to elevate the blade between the heads and latch the spittoon assembly in that position.

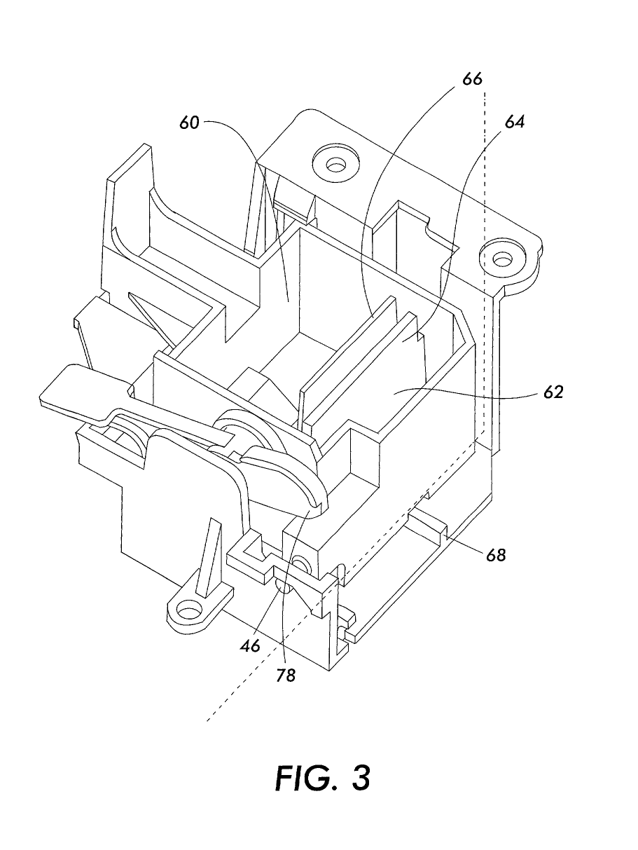

Embodiments of the present invention include an assembly guide rail 68 to keep the spittoon and wiper assembly from substantially moving in a direction perpendicular to the direction of motion of the print cartridge 8. In the embodiment shown in FIGS. 2 and 3, for example, assembly guide rail 68 does not have an incline. However, assembly guide rail 68 may be designed with a ramped portion having a ramp angle approximately equal to the angle of incline of the slots (50, 52) and the inclined ramp 59. In another embodiment, a second assembly guide rail, in line with the first assembly guide rail is used as well.

The assembly 38 can be elevated with respect to the rest of the service station 28 when the print cartridge 8 is in place over the spittoon receptacles (60, 62). The printer can be operated so that the assembly 38 will raise automatically every time the carriage is in position over the spittoon, or it could be set to occur once per a predetermined number of passes. In embodiments, a complex algorithm is used to determine whether the black printhead 10 needs a wipe based upon many different factors such as the number of copies made, the number of times the cartridge has spit, and the length of time since the last wipe. It also may be set so that the user may select a wipe during a particular maintenance pass, if he or she desires or it may include an automatic trigger such as an optical sensor or a mechanical sensor on or in contact with the carriage guide rail.

Normally, when a wipe is not taking place, the print cartridge 8 moves into position over the spittoon assembly 38, printhead 10 ejects some ink, and the print cartridge moves out of the maintenance area. The assembly 38 remains in the rest position when no wipe will occur.

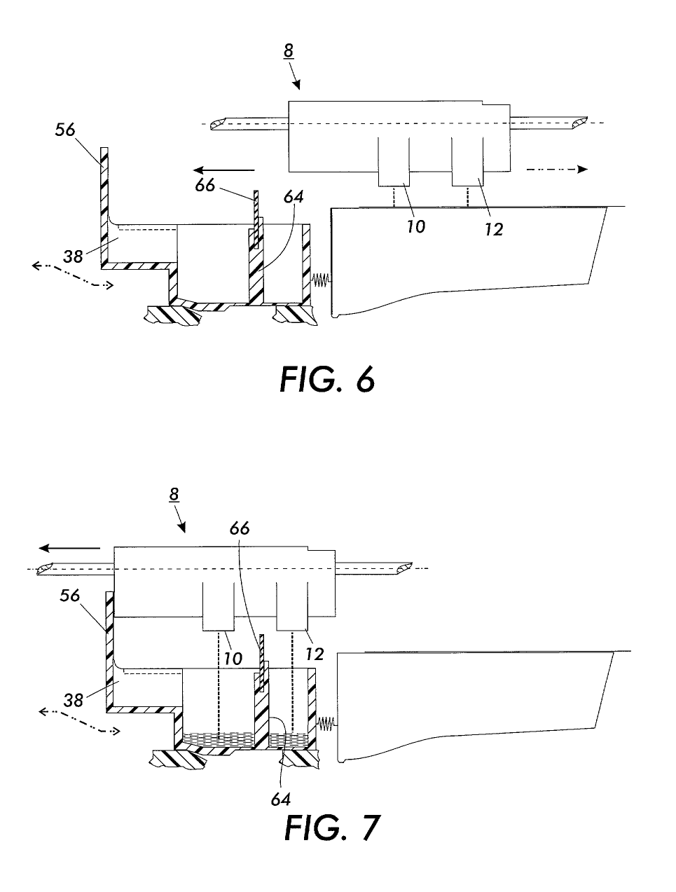

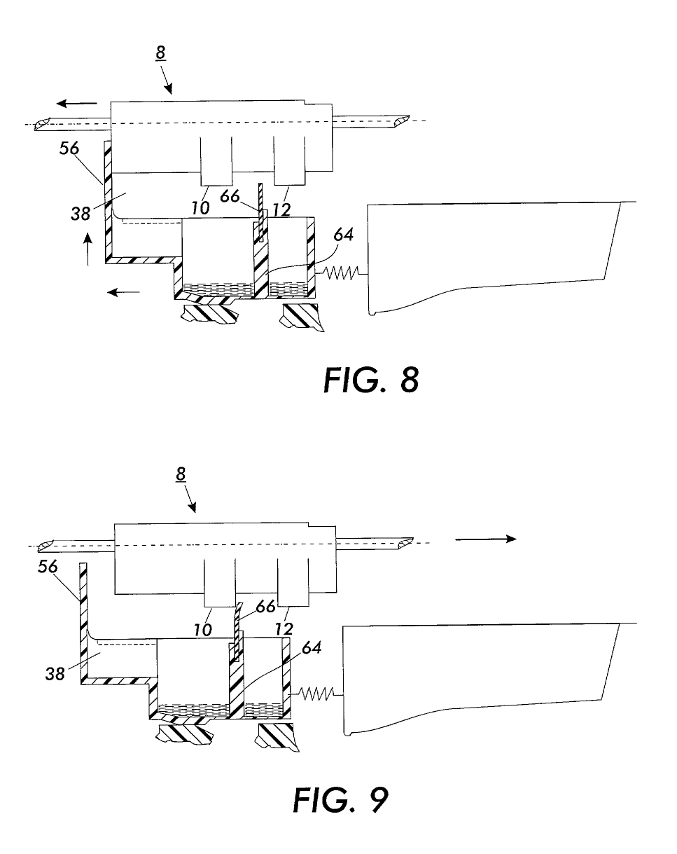

When the printer determines that the printhead 10 needs a wipe, the assembly 38 is pushed into place. This process is illustrated in FIGS. 6, 7, 8, and 9. Instead of stopping over the spittoon in its rest position, the print cartridge 8 continues on and contacts backstop 56, which is attached to the assembly 38. The carriage pushes the backstop 56, and therefore the whole spittoon assembly, backward a predetermined distance. The particular distance that the assembly travels will vary as discussed below In a particular embodiment, a distance of 6 mm yielded acceptable results. This causes the protrusions (46, 48) to slide along slots (50, 52). It also causes protrusion 54 to slide upward under overhang 58, while the base of the backstop 56 slides up the inclined ramp 59. The portion of each of slots (50, 52) located below the bend is angled upward between 0° and 90° with respect to the base of the service station 28. The exact angle of the incline will be different for different printer designs. The angle of the slots (50, 52) is approximately the same as that of the incline. It is expected that in most embodiments, the incline will range from 30° to 45°. In one particular embodiment, an angle of 45° yielded acceptable performance. The upper portion of each slot is roughly horizontal. The inclined ramp 59 flattens out into a horizontal planar surface 61. The print cartridge 8 carriage and assembly 38 move at the same speed in the same direction horizontally, but the assembly 38 moves upward as well for the first part of the travel distance, while the carriage moves only horizontally. The wiper blade 66 is positioned so that when the assembly 38 ascends, the wiper blade ends up between the black ink printhead 10 and the color printhead 12. During this motion, there is no relative sideways motion between the printheads and blade because they are moving together.

In embodiments the horizontal distance the assembly travels does not have to be 6 mm. Depending on the relative sizes of the printhead, the printer, and the spittoon, and the distance between the printhead(s) and the receptacle(s) in the spittoon, the horizontal component of the distance traveled by the spittoon assembly may vary. In most cases, the length will range from about 3 mm to about 20 mm. However, the length of the horizontal component is entirely dependent upon the configuration of the printer in which it is placed. Therefore, it is possible that values outside this range could be used.

The length of the portion of the slot that is angled upward can also vary in relative as well as absolute length. While at least part of the slot should be angled upward, there is no reason that an upper portion of the slot needs to be horizontal. The entire slot may be angled upward. For example, all of the slot may slant upward at an angle of 30° with the base of the service station. Another slot may have a portion that is angled upward at 60° with the base of the service station, while the remaining portion is horizontal. All that is required is that at least part of the slot has a vertical component that is long enough to raise the wiper blade into position to wipe the printhead.

In embodiments, the elevation of the assembly 38 may also be accomplished solely with a simple ramp or ramps. In a relatively simple embodiment, the ramp can be located behind the backstop of the spittoon assembly. The angle of the ramp can be the same as that of the lower portion of the slot. The ramp would also have a flat upper surface. However, while a ramp should work as an elevation device, it is not quite as effective as the protrusions and slots. The slots (50, 52) act as guides for the protrusions (46, 48). In embodiments, the protrusions and slots assist the assembly guide rail 68 in keeping the assembly 38 from traveling askew.

After protrusions (46, 48) reach the horizontal portions of slots (50, 52), and the base of the backstop 56 reaches the horizontal surface 61 connected to inclined ramp 59, the print cartridge 8 still continues to push the assembly 38.

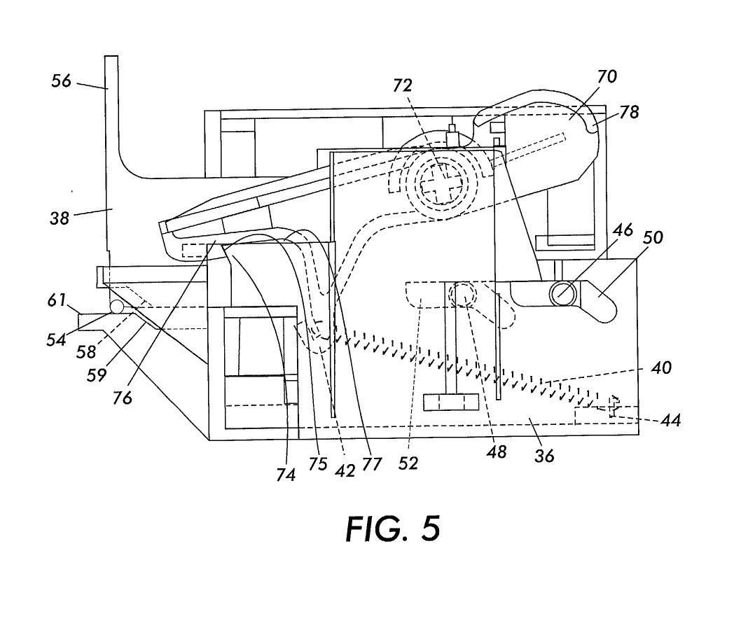

With particular reference to FIG. 5, when the assembly 38 is pushed backwards to its greatest extent, the assembly is in its fully elevated position. The distance that the spittoon assembly 38 travels forward is limited by a latching mechanism. In embodiments, the latching mechanism comprises the spring 40 in conjunction with notch 74 and ledge 76. Outer walls 75 and 77 define notch 74. When the print cartridge 8 enters the maintenance station and pushes the assembly backward and upward, the spring 40, which is attached to hook 42, supplies a torque to arm 70, pulling the end comprising notched portion 74 downward. Once it is past ledge 76, wall 75 of notch 74 travels beyond ledge 76 and is pulled downward by a combination of gravity and the torque exerted by spring 40. Wall 77, also pulled downward when wall 75 was pulled downward, eventually prevents the lever arm from moving forward. This coincides with the turnaround point for the print cartridge 8.

After the printhead 10 ejects ink into the spittoon, the print cartridge 8 reverses direction and begins to travel towards the printing area again. However, the assembly does not travel back in tandem with the print cartridge 8. As the carriage exits the maintenance area, the spring 40 begins to pull the assembly back towards its rest position. However, wall 75 of notched portion 74, which is now in a lower position, catches on ledge 76. This is known as the wipe position. As the print cartridge 8 begins leaving the maintenance station, wall 75 keeps the assembly from moving with it. It keeps the assembly, and therefore the wiper blade 66, in place in the wipe position. The ink jet printhead 10 then gets wiped as the carriage exits the maintenance system. The ink removed during this wipe is spattered away from the other printhead 12, thus, in this case, preventing black ink from contaminating the color printhead.

After the ink jet head has passed the wiper blade 66, a small protrusion (not shown) on print cartridge 8 contacts the shoulder portion 78 of arm 70 while the carriage is still exiting. This causes the shoulder portion 78 to drop and the notched portion 74, and more specifically wall 75, to rise up, allowing spring 40 to pull assembly 38 back into its lowered rest position. Shoulder portion 78 can also be referred to as a latch release tab.

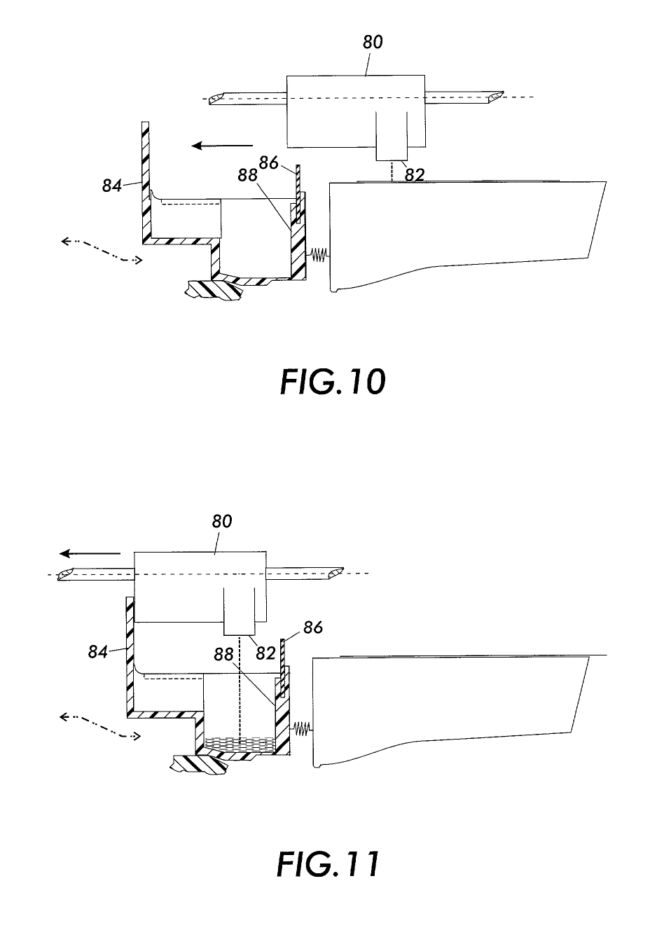

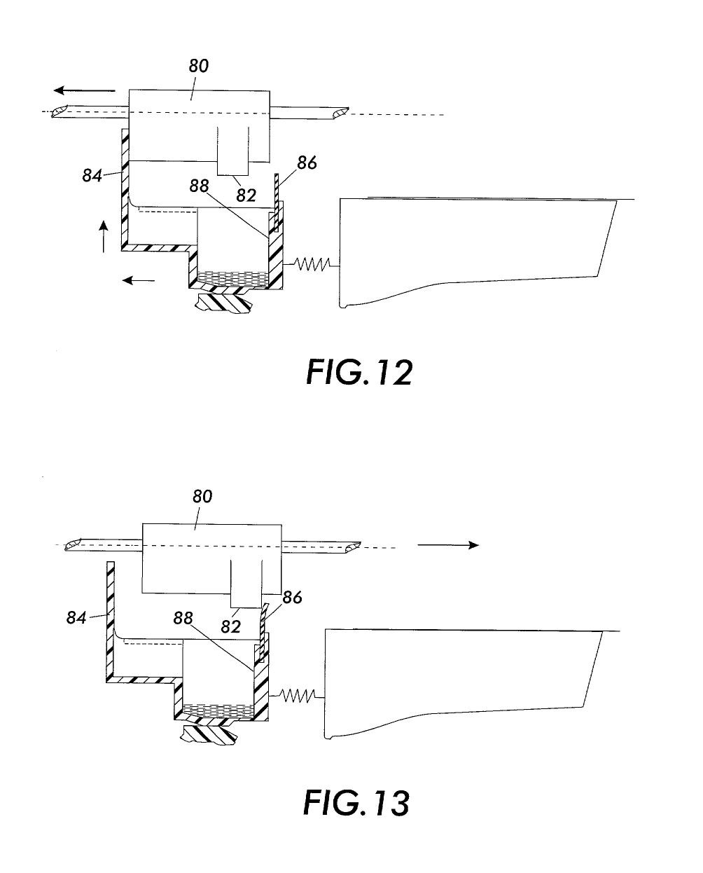

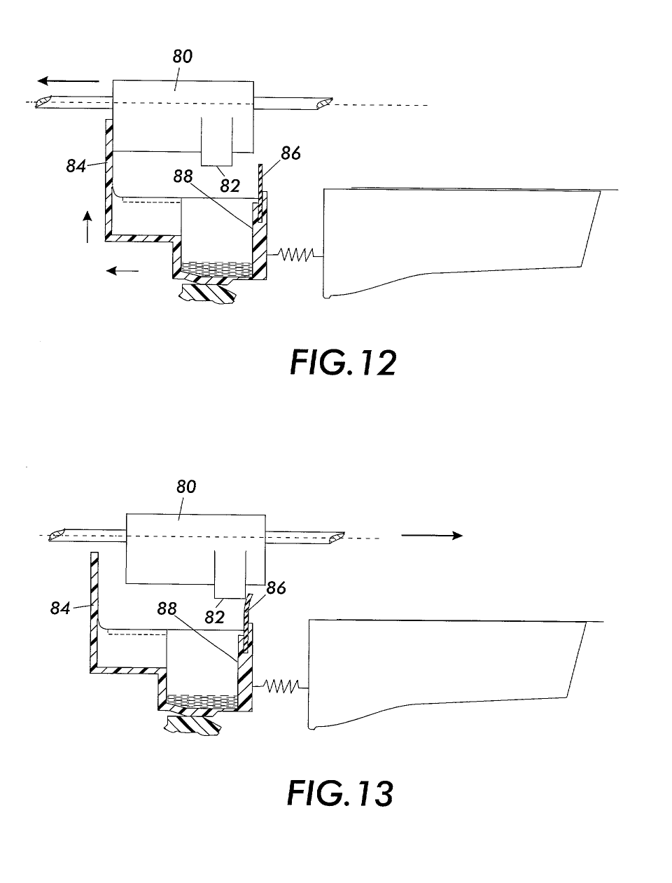

The present invention is not limited to a spittoon and wiper assembly for dual printheads. The present invention can be used with any print cartridge having a printhead nozzle face on its underside. For example, FIGS. 10, 11, 12, and 13 illustrate a print cartridge 80 having a single downward pointing printhead 82 having a nozzle face (not visible) approaching a spittoon assembly 84 similar to the one described in detail above. However, this spittoon only has one receptacle in which to collect ink. In embodiments along these lines, the wiper blade 86 is on the front exterior wall 88, rather than on the dividing wall. What was the dividing wall becomes the exterior wall. The protrusions and slots will likely have to be moved towards the rear of the maintenance station where the backstop is. However, they should not have to be moved far.

Further, this method can be used to wipe color printheads as well. Assuming that the color 12 and black ink 10 printheads are connected to black and colored inks, respectively, the same apparatus and method as disclosed in the preceding paragraphs can be used to wipe the face of printhead 10, even though printhead 10 now ejects color inks.

While the present invention has been described in connection with embodiments thereof, it will be understood that it is not intended to limit the invention to that embodiment. On the contrary, it is intended to cover all alternatives, modifications, and equivalents as may be included within the spirit and scope of the invention as defined by the appended claims.

What is claimed:

1. A fluid receiving device, comprising:
a body;
a spittoon assembly movably connected to the body, the spittoon assembly including a spittoon having a first ink collection receptacle;
an elevation mechanism connected to the spittoon assembly, that selectively elevates the spittoon assembly with respect to the rest of the device;
a wiper supported by the spittoon assembly, the wiper wipingly engaging a printhead when the spittoon assembly is in an elevated position; and
a releasable latching mechanism connecting the body and the spittoon assembly, where the latching mechanism selectively maintains the spittoon assembly in an elevated position.

2. The device of claim 1, where the elevation mechanism also moves the spittoon horizontally in a direction of motion of the printhead.

3. The device of claim 2, where the elevation mechanism includes:
a backstop connected to the spittoon assembly;
at least one first protrusion extending from the spittoon assembly;
a first slot in the body, through which the first protrusion extends;
a portion of the first slot having a length that is not parallel to a base of the device.

4. The device of claim 3, where the elevation mechanism further includes:
a second protrusion extending from the spittoon assembly;
a second slot in the body, through which the second protrusion extends;
a portion of the first slot having a length that is not parallel to the base of the device.

5. The device of claim 4, where the part of the slot not parallel to the base of the device is from about 3 mm to 10 mm long.

6. The device of claim 3, where a horizontal component of the first slot in the body is from about 3 mm to 20 mm long.

7. The device of claim 6, where the horizontal component of the first slot in the body is approximately 6 mm.

8. The device of claim 2, where the elevation mechanism includes:
a backstop connected to the spittoon assembly;
at least one first protrusion extending from the spittoon assembly; and
a first groove in the body, through which the first protrusion extends, and a portion of the first groove having a length that is not parallel to a base of the device

9. The device of claim 1, where the elevation mechanism comprises a ramp.

10. The device of claim 1, further comprising a biasing mechanism for biasing the spittoon assembly to a rest state, the biasing mechanism connecting the spittoon assembly to a wall of the device.

11. The device of claim 10, where the biasing mechanism comprises a spring.

12. The device of claim 1, wherein the latching mechanism comprises a lever arm having a notch connected to the spittoon assembly.

13. The device of claim 1, further comprising a front exterior wall, where the wiper is located atop the wall

14. The device of claim 1, where the spittoon further comprises:
a second receptacle;
a wall located between the two receptacles.

15. The device of claim 14, where the wiper is located atop the wall.

16. The device of claim 1, further comprising at least one assembly guide rail attached to the body.

17. A fluid receiving device, comprising:
a body;
a spittoon assembly slidingly connected to the body, the spittoon assembly including a spittoon having first and second receptacles;
a wall located between the first and the second receptacles;
a wiper attached to the top of the wall;
a first protrusion extending from the spittoon assembly;
a first slot in the body, through which the first protrusion extends;
a portion of the first slot having a length that is not parallel to a base of the device;
a lever arm having a notch connected to the spittoon assembly;
a spring connecting the spittoon assembly and the body.

18. The device of claim 17, further comprising:
a second protrusion extending from the spittoon assembly through a second slot in the body having a width sized to encompass the second protrusion and a length longer than a diameter of the second protrusion, and at least part of the length of the second slot is not parallel to the base of the device;

19. The device of claim 17, further comprising at least one assembly guide rail attached to the body.

20. A printhead wiping method, comprising:
providing a spittoon assembly that includes a wiper blade on a top edge of the assembly;
placing a cartridge having a printhead extending downward from the cartridge over the spittoon assembly;
elevating the spittoon assembly from a rest position to a wipe position so that the wiper blade extends above an underside of the printhead;
causing the cartridge to eject ink through the printhead into a receptacle in the spittoon assembly;
moving the cartridge so that the printhead passes over the wiper blade, which wipes the printhead; and
lowering the spittoon assembly.

21. The method of claim 20, wherein the spittoon assembly is movably connected to a stationary body.

22. The method of claim 20, wherein elevating the spittoon assembly includes moving the printhead so that it contacts a portion of the spittoon assembly causing a protrusion extending from the spittoon assembly to move within one of a slot or a groove in the body, where at least a portion of the one of a slot or a groove is not parallel to a base of the body.
